(19) United States
(12) Patent Application Publication
(10) Pub. No.: US 2002/0172882 A1
(43) Pub. Date: Nov. 21, 2002

(54) Toner for electrophotography

(76) Inventors: Takahiro Ishihara, Osaka (JP); Masami Tsujihiro, Osaka (JP); Yoichiro Watanabe, Osaka (JP); Norio Kubo, Osaka (JP); Hidekazu Tamura, Osaka (JP); Akinori Koyama, Osaka (JP); Takeshi Arakawa, Osaka (JP); Hiroshi Shimoyama, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/059,130

(22) Filed: Jan. 31, 2002

(30) Foreign Application Priority Data
Mar. 28, 2001 (JP) 2001-92394

(51) Int. Cl. G03G 9/08

(52) U.S. Cl. 430/110.4; 430/108.8; 430/108.4

(57) ABSTRACT

A toner for electrophotography is so prepared that a wax in a binder resin has an average diameter in the range from 0.1 to 3.0 μm so as to alleviate hot offsetting and filming, and that the toner contains 1.0 to 2.5% by volume of a fine particle toner with particle diameters of 5.04 μm or smaller so as to grind, at an early stage, the toner components that have attached to a photoconductor and thereby prevent filming.

### BACKGROUND OF THE INVENTION

1. Field of the Invention

The present invention relates to a toner for electrophotography, and in particular to an electrophotographic toner for use in an image formation apparatus exploiting so-called electrophotography, such as an electrostatic copier or a laser beam printer (hereinafter, such a toner will be referred to simply as a “toner” also).

2. Description of the Prior Art

In an image formation apparatus exploiting electrophotography, as the development of an image proceeds, toner components may adhere to the surface of a photoconductor or the like, a phenomenon called filming. This filming is considered to occur by the following mechanism. Toner particles attached to the surface of the photoconductor remain on a cleaning member, for example a cleaning blade, and, under the heat produced by friction between the cleaning blade the rotating photoconductor and the pressure exerted by the cleaning blade, the binder resin and wax contained in the toner as its ingredients soften and deposit in the form of a thin film on the surface of the photoconductor. In particular, when the toner is charged positively, the fiber of paper, which is widely used as a transfer material, tends to be negatively charged, and therefore the toner and the fiber of paper attract each other and form a flock. This flock attaches to the photoconductor and remains on the cleaning member, making filming more likely to occur.

When such filming occurs, during the exposure of an image, part of the light corresponding to the pattern of the image is blocked, which makes it impossible to form an electrostatic latent image that correctly reflects the pattern of the image, causing an image defect such as a black blot in regular development and an image defect such as a white patch in reversal development.

In recent years, from the viewpoint of reducing the production cost of a toner, much research has been done to examine whether it is possible or not to use a single type of toner in a plurality of image formation apparatus, from low-speed to high-speed models. However, with a single type of toner, filming becomes more striking as the development speed becomes higher. The reason is that, the higher the development speed, the shorter the fixing time, and thus the less heat is applied to the toner per unit time. Accordingly, to make a toner fixable with less heat, it is customary to lower the softening point of the binder resin contained in the toner. However, lowering the softening point of the binder resin results in lowering the strength of the binder resin itself, making it more likely to attach to the photoconductor. This problem may be solved by increasing the fixing temperature in an image formation apparatus operating at high development speed so as to increase the heat applied to the toner per unit time. This, however, is undesirable in practical terms because it invites increased electric power consumption, increased temperature inside the apparatus, and longer warm-up time. On the other hand, when a toner containing a binder resin with a low softening point is used in an image formation apparatus operating at low development speed, the insufficient viscoelasticity of the binder resin causes a phenomenon called hot offsetting.

In view of these problems, for example, Japanese Patent Application Laid-Open No. H9-127718 discloses a technology whereby a particular wax dispersing agent is contained in a binder resin having a particular molecular weight distribution so as to adjust the particle size distribution of the wax in the resin for the purpose of preventing hot offsetting and filming. However, even with this technology, it is not possible to satisfactorily prevent filming on a photoconductor.

### SUMMARY OF THE INVENTION

An object of the present invention is to provide a toner that can be used in image formation apparatus operating in a wide range of development speed, i.e. from low-speed to high-speed models, and that does not cause hot offsetting or filming.

To achieve the above object, according to the present invention, in a toner for electrophotography comprising a wax and a colorant dispersed in and thereby mixed with a binder resin, the average diameter of the wax in the binder resin is in the range from 0.1 to 3.0 μm, and the toner contains 1.0 to 2.5% by volume of a toner with particle diameters of 5.04 μm or smaller (hereinafter referred to as a “fine particle toner” also). It is to be noted that, in the present specification, the average diameter of a wax denotes the average of the maximum particle diameter of the wax as observed in a TEM (transmission electron microscope) sectional photograph, and the particle diameter and the percentage by volume of a toner are values measured with a “Coulter counter.”

Here, for better fixability and for securer prevention of filming, it is preferable that the average diameter of the wax be in the range from 0.9 to 2.5 μm. On the other hand, for efficient grinding and elimination of filming components and for securer prevention of the lowing of the toner's flowability, it is preferable that the toner contain 1.5 to 2.3% by volume of the fine particle toner mentioned above.

From the viewpoint of easier control of the average diameter of the wax, it is preferable that a wax dispersing agent be additionally dispersed in and thereby mixed with the binder resin. Here, it is preferable that 0.1 to 5 parts by weight of the wax dispersing agent be dispersed in and thereby mixed with 100 parts by weight of the binder resin.

For effective grinding of filming components originating from the fine particle toner, of which a description will be given later, it is preferable to use carbon black as the colorant. Here, it is preferable that 8 to 13 parts by weight of the carbon black be contained in 100 parts by weight of the binder resin.

For still securer prevention of offsetting and filming, it is preferable that the volume-average particle diameter (the median diameter as measured with a “Coulter counter”) of the toner be in the range from 7 to 13 μm.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a diagram showing the relationship between the mixed percentage of the fine particle toner and the ground depth of the photoconductor.

### DESCRIPTION OF THE PREFERRED EMBODIMENTS

As a result of an intensive study made to examine whether it is possible or not to obtain a toner that can be used in a plurality of image formation apparatus, from low-speed to high-speed models, and that does not cause hot offsetting or filming, the inventors of the present invention have found out that increasing the diameter of a wax dispersed in a binder resin helps improve the mold-releasability of the toner and thereby alleviate hot offsetting in a fuser unit, but that doing so too far makes the toner more likely to attach to a photoconductor and thus makes filming more likely to occur. It has also been found out that, even when the average diameter of the wax is controlled within a particular range, it is impossible to prevent hot offsetting and filming completely. In addition, it has been found out that a fine particle toner exerts a grinding effect, which finding has led to the present invention.

Specifically, according to the present invention, the average diameter of a wax in a binder resin is controlled so as to alleviate the occurrence of hot offsetting and filming. Moreover, the toner components that have attached to a photoconductor which eventually cause filming are ground, at an early stage, with a fine particle toner so as to prevent filming completely.

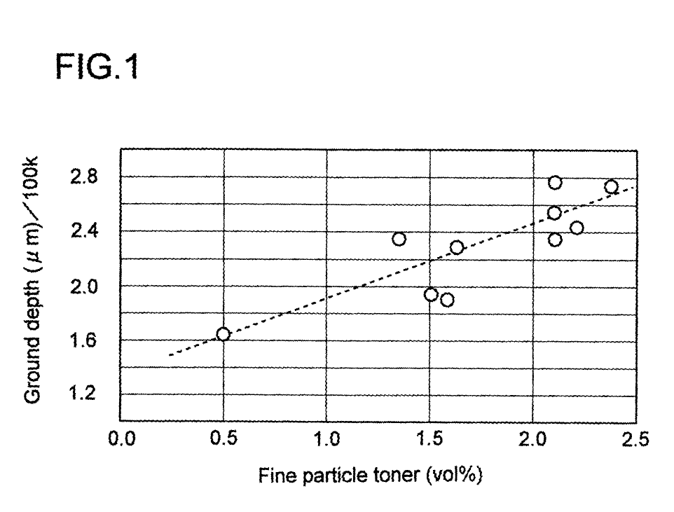

One distinctive feature of a toner according to the present invention is that it contains 1.0 to 2.5% by volume of a toner with particle diameters of 5.04 μm or smaller. FIG. 1 shows the relationship between the percentage of the fine particle toner mixed and the depth of a photoconductive layer ground, as observed with a photoconductor having a 40 μm thick organic photoconductive layer formed on the surface thereof FIG. 1 shows that, as the percentage of the fine particle toner mixed increases, the depth of the photoconductive layer ground increases. In general, to remove filming components on a photoconductor, the photoconductor needs to be ground by about 2 μm for every 10,000 sheets of paper processed. Based on this fact and what is shown in FIG. 1, a preferred lower limit of the percentage of the fine particle toner mixed is 1.0% by volume, and further preferably 1.5% by volume. On the other hand, with the percentage of the fine particle toner higher than 2.5% by volume, the toner exhibits poor flowability. Thus, a preferred upper limit of the percentage of the fine particle toner mixed is 2.5% by volume, and further preferably 2.3% by volume.

The percentage of the fine particle toner mixed is controlled by a conventionally know method. For example, in the classification process in the course of the manufacture of the toner, of which a description will be given later, the degree of classification performed is controlled, or the toner is mixed with a small particle toner that has been prepared separately, in either case in such a way that the toner contains the desired percentage of the fine particle toner.

A preferred volume-average particle diameter of a toner according to the present invention is 7 to 13 μm. With average diameters smaller than 7 μm, too much of the toner remains on a photoconductor, making filming likely to occur. On the other hand, with average diameters larger than 13 μm, heat does not conduct evenly around the toner in a fuser unit, making cold offsetting likely to occur.

Another distinctive feature of a toner according to the present invention is that the average diameter of a wax dispersed in a binder resin is in the range from 0.1 to 3.0 μm. With the average diameter of the wax smaller than 0.1 μm, no improvement is achieved in fixability. On the other hand, with the average diameter larger than 3.0 μm, the wax separates from the toner and attaches to the surface of a photoconductor, ready to cause filming. A further preferred average diameter of the wax is in the range from 0.9 to 2.5 μm.

The average diameter of the wax in the binder resin can be controlled within the aforementioned range by adjusting the processing conditions in the manufacture of the toner, in particular in the melting-kneading process. Specifically, a kneading machine is heated to several to tens of degrees Celsius higher than the softening point of the binder resin, and then the toner composition in a melted state is subjected to an adequate shearing/agitating force so that the wax has the desired average diameter. To prompt the dispersion of the wax in the binder resin, a wax dispersing agent may be added to the binder resin. In the melting-kneading process, the wax dispersing agent melts onto the surfaces of wax particles in the melted binder resin and thereby prevents the wax particles to gather together to form larger wax particles. This permits the wax to be dispersed in the binder resin uniformly and with the aforementioned average diameter maintained. The wax dispersing agent used here may be of any conventionally known type, of which an example is a block copolymer of a styrene polymer and an olefin. Preferably 0.1 to 5 parts by weight of the wax dispersing agent is added to 100 parts by weight of the binder resin.

The wax used in the present invention may be of any conventionally known type, examples of which include: esters of a fatty acid with a polyhydric alcohol; esters of a fatty acid with a higher alcohol; amides of an alkylenebis fatty acid; natural waxes; and polypropylene, polyethylene, and propylene-ethylene copolymer with a number-average molecular weight in the range from 1,000 to 10,000, in particular in the range from 2,000 to 6,000. Preferably 0.1 to 10 parts by weight of the wax is added to 100 parts by weight of the binder resin.

There are no particular restrictions on the type of binder resin used in the present invention, examples of which include styrene-acrylic resin and polyester resin. Needless to say, as required, these types of resin may be used in combination with another type of resin.

Examples of the monomers that are used as the base of the styrene-acrylic resin include: derivatives of styrene such as styrene, α-methylstyrene, p-methylstyrene, p-t-butylstyrene, p-chlorstyrene, and hydroxystyrene; and esters of (meth)acrylic acid such as methacrylic acid, methyl (meth)acrylate, ethyl (meth)acrylate propyl (meth)acrylate, butyl (meth)acrylate, glycidyl (meth)acrylate, methoxyethyl (meth)acrylate, propoxyethyl (meth)acrylate, methoxydiethylene glycol (meth)acrylate, ethoxydiethylene glycol (meth)acrylate, benzil (meth)acrylate, cyclohexyl (meth)acrylate, tetrahydrofurfuryl (meth)acrylate, (meth)acrylonitrile, (meth)acrylamide, N-methylol (meth)acrylamide, ethylene glycol di(meth)acrylate, 1,3-butylene glycol di(meth)acrylate, 1,4-butanediol di(meth)acrylate, and trimethylol ethane tri(meth)acrylate.

A mixture of some of these monomers is made into the binder resin used in the present invention by polymerizing the mixture by an appropriate process such as solution polymerization, block polymerization, emulsion polymerization, or suspension polymerization. The polymerization initiator that can be used in the polymerization process here may be of any conventionally known type, examples of which include: acetyl peroxide, decanoyl peroxide, lauroyl peroxide, benzoyl peroxide, azobisisobutyronitrile, 2,2′-azobis-2,4-dimethylvaleronitrile, and 2,2′-azobis-4-methoxy-2,4-dimethylvaleronitrile. Preferably 0.1 to 15% by weight of one of these polymerization initiators is added to the total weight of the monomers.

The polyester resin is produced mainly through condensation polymerization of a polycarboxylic acid and a polyhydric alcohol. Examples of the polycarboxylic acid include: aromatic polycarboxylic acids such as phthalic acid, isophthalic acid, terephthalic acid, succinic acid, 1,2,4-benzenetricarboxylic acid, 2,5,7-naphthalenetricarboxylic acid, 1,2,4-naphthalenetricarboxylic acid, and pyromellitic acid; aliphatic dicarboxylic acids such as maleic acid, fumaric acid, succinic acid, adipic acid, sebacic acid, malonic acid, azelaic acid, mesaconic acid, citraconic acid, and glutaconic acid; alicyclic dicarboxylic acids such as cyclohexane dicarboxylic acid and cyclohexenedicarboxylic acid; and anhydrides and lower alkyl esters of these carboxylic acids. These are used singly or as a mixture of two or more of them.

Here, the content of components with three or more carboxyl or hydroxy groups depends on the degree of cross-linking, and therefore the desired degree of cross-linking can be achieved by adjusting the amount of such components added. In general, a preferred content of components with three or more carboxyl or hydroxy groups is 15 mol % or lower.

On the other hand, examples of the polyhydric alcohol used in the polyester resin include: alkylene glycols such as ethylene glycol, 1,2-propylene glycol, 1,3-propylene glycol, 1,4-butanediol, 1,4-butenediol, neopentyl glycol, 1,5-pentane glycol, and 1,6-hexane glycol; alkylene ether glycols such as diethylene glycol, triethylene glycol, dipropylene glycol, polyethylene glycol, polypropylene glycol, and polytetramethylene glycol; alicyclic polyhydric alcohols such as 1,4-cyclohexame dimethanol and hydrogenated bisphenol A; and bisphenols such as bisphenol A, bisphenol F, and bisphenol S, and alkylene oxides of such bisphenols. These are used singly or as a mixture of two or more of them.

As required, monocarboxylic acids and monohydric alcohols may be used for the purpose of adjusting the molecular weight and controlling the reaction. Examples of monocarboxylic acids include benzoic acid, p-hydroxybenzoic acid, toluenecarboxylic acid, salicylic acid, acetic acid, propionic acid, and stearic acid. Examples of monohydric alcohols include benzil alcohol, toluene-4-methanol, and cyclohexane methanol.

The polyester resin used in the present invention is produced from these materials by an ordinary process. For example, the alcohol and acid components in predetermined proportions are put in a reaction vessel, and then, with an inert gas such as nitrogen kept blown into them, their reaction is started in the presence of a catalyst at a temperature of 150 to 190° C. The low-molecular-weight compounds that are produced as by-products are continuously driven out of the reaction system. Thereafter, the reaction temperature is raised to 210 to 250° C. to prompt the reaction and obtain the desired polyester resin. The reaction is possible under any of normal, reduced, or increased pressure. Prefererably, once the reaction rate has reached 50 to 90%, the reaction is continued under reduced pressure of 200 mmHg or lower.

Examples of the catalyst mentioned above include: metals such as tin, titanium antimony, manganese, nickel, zinc, lead, iron, magnesium, calcium, or germanium; and compounds of these metals.

It is preferable that the binder resin used in the present invention have a glass transition point in the range from 45 to 90° C. With a glass transition point below 45° C., the binder resin may gather together inside a toner cartridge or a developer unit. On the other hand, with a glass transition point over 90° C., the toner may not fuse satisfactorily onto a transfer material such as paper.

In the present invention, the following substances can be used as the colorant. Examples of black pigments include: carbon black such as acetylene black, lamp black, and aniline black. Examples of yellow pigments include: chrome yellow, zinc yellow, cadmium yellow, yellow iron oxide, mineral fast yellow, nickel-titanium yellow, naphthol yellow S, Hansa yellow G, Hansa yellow 10G, benzidine yellow G, benzidine yellow GR, quinoline yellow lake, permanent yellow NCG, and tartrazine lake. Examples of orange pigments include: chrome orange, molybdate orange, permanent orange GTR, pyrazolone orange, vulcan orange, indanthrene brilliant orange RK, benzidine orange G, and indanthrene brilliant orange GK. Examples of red pigments include: red iron oxide, cadmium red, minium (red lead), mercury cadmium sulfide, permanent red 4R, lithol red, pyrazolone red, watching red calcium salt, lake red D, brilliant carmin 6B, eosin lake, rhodamine lake B, alizarin lake, and brilliant carmin 3B. Examples of violet pigments include: manganese violet, fast violet B, and methyl violet lake. Examples of blue pigments include: iron blue, cobalt blue, alkali blue lake, Victoria blue lake, phthalocyanine blue, metal-free phthalocyanine blue, partially chlorinated phthalocyanine blue, fast sky blue, and indanthrene blue BC. Examples of green pigments include: chrome green, chromium oxide, pigment green B, malachite green lake, and final yellow green G. Examples of white pigments include: zinc white, titanium oxide, antimony white, zinc sulfide, baryta powder, barium carbonate, clay, silica, white carbon, talc, and alumina white. These colorants may be used singly or as a mixture of two or more of them.

Preferably 0.1 to 20 parts by weight, and particularly preferably 1 to 15 parts by weight, of the colorant(s) in total is added to 100 parts by weight of the binder resin.

Among the colorants mentioned above, a preferred one in development using a black color is carbon black for its good grindability. A further preferred content of carbon black is in the range from 8 to 13 parts by weight.

A toner according to the present invention can be manufactured by a process that itself is conventionally known, such as crushing-and-classifying, melt granulation, spray granulation, or suspension/emulsification polymerization. Among these, from the viewpoint of manufacturing equipment and productivity, a preferred process is crushing-and-classifying. Crushing-and-classifying is performed in the following manner. First, the toner composition containing a binder resin, a colorant, and a wax, with a charge control agent and a magnetic powder added thereto as required, is premixed in a Henschel mixer or a V-blender, and is then melt and kneaded in a melting-kneading machine such as a twin-screw extruder. The toner composition thus melted and kneaded is cooled, is then subjected to coarse/fine crushing, and is then, as required, classified to obtain toner particles having the desired particle size distribution. As required, the surfaces of the toner particles are treated with a surface treatment agent to obtain the toner according to the present invention.

Here, as the charge control agent can be used any conventionally known type, examples of which include: as charge control agents that tend to be positively charged, nigrosine dyes, nigrosine dyes denatured with a fatty acid, nigrosine dyes denatured with a fatty acid containing a carboxyl group, quaternary ammonium salts, amine-based compounds, and organic metallic compounds; and, as charge control agents that tend to be negatively charged, metallic complexes of a hydroxycarboxylic acid, metallic complexes of an azo compound, metal complex dyes, and salicylic acid derivatives. Preferably 0.1 to 10 parts by weight of the charge control agent is added to 100 parts by weight of the binder resin.

Examples of the magnetic power that is added to alleviate the scattering or the like of the toner when it is insufficiently charged electrically include: triiron tetroxide (Fe₃O₄), iron sesquioxide (γ-Fe₂O₃), iron zinc oxide (ZnFe₃O₄), iron yttrium oxide (Y₃Fe₅O₁₂), iron cadmium oxide (CdFe₂O₄), iron gadolinium oxide (Gd₃Fe₅O₁₂), iron copper oxide (CuFe₂O₄), iron lead oxide (PbFe₁₂O₁₉), iron nickel oxide (NiFe₂O₄), iron neodyum oxide (NdFeO₃), iron barium oxide (BaFe₁₂O₁₉), iron magnesium oxide (MgFe₂O₄), iron manganese oxide (MnFe₂O₄), iron lanthanum oxide (LaFeO₃), iron powder (Fe), cobalt powder (Co), and nickel powder (Ni). Among these types of magnetic powder, a particularly preferred one is fine particle triiron tetroxide (magnetite). Suitable magnetite has regular-octahedral particles 0.05 to 1.0 μm across. Magnetite particles may be subjected to surface treatment using a silane coupler or a titanium-based coupler. The magnetic powder is added in small amounts; specifically, preferably 0.1 to 5 parts by weight, and particularly preferably 0.5 to 3.0 parts by weight, of it is added to 100 parts by weight of the binder resin.

A toner according to the present invention can be used as a single-component developer or a two-component developer. When it is used as a two-component developer, there are no particular restrictions on the type of carrier that can be used together, examples of which include: magnetic metals such as iron, nickel, and cobalt, alloys of these metals, and alloys of these metals containing a rare-earth element; iron-based oxides such as hematite, magnetite, manganese-zinc ferrites, nickel-zinc ferrites, manganese-magnesium ferrites, soft ferrites such as lithium ferrites, and copper-zing ferrites; magnetic particles produced by subjecting a magnetic material, such as a mixture of some of those mentioned above, to sintering and atomizing or the like; and particles obtained by coating the surfaces of such magnetic particles with a resin. As the carrier, it is also possible to use a resin having a magnetic material dispersed therein. In this case, as the magnetic material can be used one of the magnetic materials mentioned above, and as the binder resin can be used, for example, vinyl-based resin, polyester-based resin, epoxy resin, phenol resin, urea resin, polyurethane resin, polyimide resin, cellulose resin, polyether resin, or a mixture of some of these.

A preferred particle diameter of the carrier is 30 to 200 μm, and further preferably 50 to 150 μm, as observed under an electron microscope as generally practiced. A preferred range of the apparent density of the carrier is from 2.4 to 3.0 g/cm³, though subject to variation according to the composition, the surface structure, and the like of the magnetic material when one is used as the main ingredient.

In the two-component developer composed of the toner and carrier mentioned above, a preferred toner concentration is 1 to 10% by weight, and further preferably 1 to 7% by weight. With a toner concentration below 1% by weight, the produced image has too low density. On the other hand, with a toner concentration over 10% by weight, the toner may scatter inside a developer unit, making the inside of the image formation apparatus dirty and causing the toner to attach to the background portion of sheets of transfer paper.

There are no particular restrictions on the type of photoconductor used together with a toner according to the present invention; that is, it is possible to use a photoconductor of any conventionally known type, such as a selenium based, organic substance based, or amorphous silicon based type.

Preparation of Toners and Two-Component Developers

In a Henschel mixer, 10 parts by weight of stryrene-acrylic resin, as a binder resin, containing a mold release agent (a paraffin wax and a hydrocarbon wax), 12 parts by weight of carbon black as a colorant, 1 part by weight of a charge control agent, and 1.5 parts by weight of magnetite as magnetic powder were put and then blended. The mixture was then melted and kneaded in a twin-screw extruder, and was then cooled in a drum flaker. The mixture was then subjected to coarse crushing on a hammer mill and then to fine crushing on a jet mill, and was then classified with a pneumatic classifier. In this way, as shown in Table 1, eight types of toner particles were prepared that all had a volume-average particle diameter of 10.0 μm but that differed in the average diameter of the wax and the percentage by volume of particles with particle diameters of 5.04 μm or smaller.

To 100 parts by weight of each of these types of toner particles, 0.5 part by weight of hydrophobic silica and 0.05 part by weight of titanium oxide were added as a surface treatment agent. The mixture was then violently agitated and mixed in a Henschel mixer to obtain a toner as an end product. The flowability of this toner was measured in the manner described below.

Next, each of the toners prepared as described above was blended with a ferrite carrier having an average particle diameter of 80 μm and having its particle surfaces coated with silicone resin in such a way that the toner concentration was 5% by weight. The mixture was then agitated and mixed uniformly to obtain a two-component developer. With this two-component developer, tests were conducted in the manner described below to check whether it caused filming or offsetting nor not. The results are also shown in Table 1.

Flowability

With each type of toner particles, Carr's index of flowability was measured, with a value greater than 60 marked with “OK” and a value smaller than 59 marked with “NG.”

Filming

Each of the developers prepared as described above was loaded in an electrophotographic copier manufactured by Kyocera Mita Corporation, Japan (sold under the trade name “Creage 7350,” a high-speed model), and copying was performed on 10,000 sheets of paper. Thereafter, the photoconductor was visually checked for filming, with nonoccurrence of filming marked with “OK” and occurrence of filming marked with “NG.”

Offsetting

Each of the developers prepared as described above was loaded in an electrophotographic copier manufactured by Kyocera Mita Corporation, Japan (sold under the trade name “Creage 8322,” a high-speed model), and then whether offsetting occurred or not was visually checked, with nonoccurrence of offsetting marked with “OK” and occurrence of offsetting marked with “NG.”

Table 1 shows the following. The toners of Practical Examples 1 to 3, which embodied the present invention, exhibited good flowability irrespective of the polarity with which they tended to be electrically charged, and did not cause filming nor offsetting. On the other hand, with the toner of Comparative Example 1, of which the fine particle toner content was as high as 2.9% by volume, the flowability was so poor that it was impossible to conduct image testing. With the toner of Comparative Example 4, of which the fine particle toner content was as low as 9.9% by volume, the grinding effect originating from the fine particle toner was so insufficient that filming occurred on the photoconductive drum. With the toner of Comparative Example 2, of which the average diameter of the wax was as small as 0.04 μm, the mold releasing effect of the wax was so insufficient that hot offsetting occurred. With the toners of Comparative Examples 3 and 5, of which the average diameter of the wax was as large as 4.2 μm and 3.2 μm respectively, the wax separated from the toner and attached to the surface of the photoconductive drum, causing filming.

TABLE 1

| | | | Particles | | | |
|---|---|---|---|---|---|---|
| | | Wax | 5.04 μm | | | Off- |
| | | Average | Across or | | Filming | setting |
| | Toner | Diam- | Smaller | | (High- | (Low |
| | Charge | eter | (% by | Flow- | Speed | Speed |
| | Polarity | (μm) | Volume) | ability | Model) | Model) |
| Practical | Positive | 2.1 | 1.7 | OK | OK | OK |
| Example 1 | | | | | | |
| Practical | Positive | 0.9 | 1.2 | OK | OK | OK |
| Example 2 | | | | | | |
| Practical | Negative | 1.6 | 1.2 | OK | OK | OK |
| Example 3 | | | | | | |
| Com- | Positive | 2.5 | 2.9 | NG | — | — |
| parative | | | | | | |
| Example 1 | | | | | | |
| Com- | Positive | 0.04 | 1.5 | OK | OK | NG |
| parative | | | | | | |
| Example 2 | | | | | | |
| Com- | Positive | 4.2 | 1.7 | OK | NG | OK |
| parative | | | | | | |
| Example 3 | | | | | | |
| Com- | Positive | 1.3 | 0.9 | OK | NG | OK |
| parative | | | | | | |
| Example 4 | | | | | | |
| Com- | Positive | 3.2 | 2.1 | OK | NG | OK |
| parative | | | | | | |
| Example 5 | | | | | | |

What is claimed is:

1. A toner for electrophotography comprising a wax and a colorant dispersed in and thereby mixed with a binder resin,
wherein an average diameter of the wax in the binder resin is in a range from 0.1 to 3.0 μm, and
the toner contains 1.0 to 2.5% by volume of a toner with particle diameters of 5.04 μm or smaller.

2. A toner for electrophotography as claimed in claim 1, wherein the average diameter of the wax is in a range from 0.9 to 2.5 μm.

3. A toner for electrophotography as claimed in claim 1, wherein the toner contains 1.5 to 2.3% by volume of the toner with particle diameters of 5.04 μm or smaller.

4. A toner for electrophotography as claimed in claim 1, further comprising a wax dispersing agent dispersed in and thereby mixed with the binder resin.

5. A toner for electrophotography as claimed in claim 4, wherein 0.1 to 5 parts by weight of the wax dispersing agent is dispersed in and thereby mixed with 100 parts by weight of the binder resin.

6. A toner for electrophotography as claimed in claim 1, wherein the colorant is carbon black.

7. A toner for electrophotography as claimed in claim 6, wherein 8 to 13 parts by weight of the carbon black is contained in 100 parts by weight of the binder resin.

8. A toner for electrophotography as claimed in claim 1, wherein a volume-average particle diameter of the toner is in a range from 7 to 13 μm.
